(19) United States
(12) Patent Application Publication
(10) Pub. No.: US 2016/0253722 A1
(43) Pub. Date: Sep. 1, 2016

(54) AGGREGATING, PRESENTING AND FULFILLING A NUMBER OF CATALOGS

(71) Applicant: HEWLETT PACKARD ENTERPRISE DEVELOPMENT LP, Houston, TX (US)

(72) Inventors: Christopher Johnson, Ft. Collins, CO (US); Stephane Herman Maes, Sunnyvale, CA (US)

(73) Assignee: Hewlett-Packard Development Company, L.P., Houston, TX (US)

(21) Appl. No.: 15/028,772

(22) PCT Filed: Oct. 31, 2013
(86) PCT No.: PCT/US2013/067870

§ 371 Date: Apr. 12, 2016

(51) Int. Cl. G06Q 30/06; G06F 17/30; H04L 29/06; H04L 29/08

(52) U.S. Cl. CPC G06Q 30/0603; H04L 67/10; G06F 17/30598; G06F 17/30345; H04L 63/102

(57) ABSTRACT

A method for aggregating, presenting, and fulfilling a number of catalogs is described. The method includes designating a server from a number of servers as a central server, receiving, at the central server, a number of catalogs from the number of servers, obtaining catalog information for the number of catalogs from the number of servers, and grouping the catalog information for the number of catalogs into an aggregated catalog.

### BACKGROUND

An increasingly larger number of business entities and individuals are turning to cloud computing and the services provided through a cloud computing system in order to, for example, sell goods or services, maintain business records, and provide individuals with access to computing resources, among other cloud-related objectives. Cloud services may be presented in a catalog that is a repository of cloud services and resources related to the provision of cloud services.

### BRIEF DESCRIPTION OF THE DRAWINGS

The accompanying drawings illustrate various examples of the principles described herein and are a part of the specification. The illustrated examples do not limit the scope of the claims.

FIG. 1 is a diagram of a system for aggregating, presenting, and fulfilling a number of catalogs, according to one example of the principles described herein.

FIG. 2 is a flowchart of a method for aggregating, presenting, and fulfilling a number of catalogs, according to one example of the principles described herein.

FIG. 3 is a diagram of another system for aggregating, presenting, and fulfilling a number of catalogs, according to one example of the principles described herein.

FIG. 4 is a diagram of a number of servers for aggregating, presenting, and fulfilling a number of catalogs, according to another example of the principles described herein.

FIG. 5 is a flowchart of another method for aggregating, presenting, and fulfilling a number of catalogs, according to one example of the principles described herein.

FIG. 6 is a thread diagram of a method of acquiring catalog information, according to one example of the principles described herein.

FIG. 7 is a diagram of a system for fulfilling an offering, according to one example of the principles described herein.

Throughout the drawings, identical reference numbers designate similar, but not necessarily identical, elements.

### DETAILED DESCRIPTION

Cloud services present users the ability to sell goods or services, maintain business records, and provide individuals with access to computing resources, among other objectives using a cloud network. Catalogs may allow a user to select, or tailor a cloud service to meet their objectives. Catalogs may also present a number of cloud service related resources such as subscription management, pricing information, subscription requests, and approvals among other cloud service management resources. However, current methods for presentation of cloud services and related resources may be inefficient and may lead to dissatisfied customer experiences.

For example, a system may include a number of different catalogs to present a number of offerings. More specifically, a system may include a number of different applications that each has associated catalogs and portals for presenting the catalogs. The various portals and catalogs may lead to confusion when selecting offerings and managing the offerings as each portal and corresponding catalog may have a different look and feel. The disorganized nature of catalogs may confuse consumers and accordingly may reduce the efficiency of a catalog.

Accordingly, the present disclosure describes systems and methods for aggregating, presenting, and fulfilling a number of catalogs. More specifically, the systems and methods described herein may describe an aggregated catalog that combines a number of other catalogs from a number of servers. In some examples, the number of servers, and the corresponding catalogs, may be remote to the aggregated catalog. An aggregated catalog may be beneficial in that it presents a unified platform for disbursement of cloud services, or other offerings, regardless of the location of the catalog and the portal that presents the catalog.

The present disclosure also describes a system of application programming interfaces (APIs) that are included in the various servers. Via the APIs, a central server that stores the aggregated catalog may retrieve information for other catalogs, which other catalogs may then be aggregated into the aggregated catalog.

The present disclosure describes a method for aggregating, presenting, and fulfilling a number of catalogs. The method may include designating a server from a number of servers as a central server. The method may also include receiving, at the central server, a number of catalogs from the number of servers. The method may also include obtaining catalog information for the number of catalogs from the number of servers. The method may further include grouping the catalog information for the number of catalogs into an aggregated catalog.

The present disclosure describes a system for aggregating, presenting, and fulfilling a number of catalogs. The system may include a central database to store an aggregated catalog. The aggregated catalog may include catalog information for a number of catalogs. The system may also include an obtain module to obtain the catalog information from a number of a servers. The system may also include an interface to present the catalog information as an aggregated catalog.

The present disclosure describes a computer program product for aggregating, presenting, and fulfilling a number of catalogs. The computer program product may include a computer readable storage medium that may include computer usable program code embodied therewith. The computer usable program code may include computer usable program code to, when executed by a processor, designate a server from a number of servers as a central server; receive, at the central server, a number of catalogs from a number of other servers; obtain, from the number of other servers, catalog information relating to a number of catalogs; group the catalog information into an aggregated catalog; and present the aggregated catalog.

The systems and methods described herein may be beneficial by presenting a number of catalogs in a single location regardless of differing portal interfaces and catalog characteristics. Accordingly, consumers may more easily navigate the unified portal, which may lead to a more satisfactory consumer experience.

As used in the present specification and in the appended claims, the term “catalog information” may include any information relating to the deployment, provision, or management of a cloud service, or other offering. For example, catalog information may include cloud service offerings, subscription requests, subscription approvals, and service pricing, among other cloud service management information.

Further, as used in the present specification and in the appended claims, the term “tenant” may refer to a user that runs an instance of an offering catalog. For example, an aggregated catalog may allow multi-tenancy, which may refer to a characteristic of the aggregated catalog to allow multiple users to subscribe to and interact with a single instance of the aggregated catalog. In this example, each tenant may subscribe to and interact with their instance of the aggregated catalog without interacting with other tenants' information. Access to the aggregated catalog may be controlled using a central identity management service. The central identity management service may enable role-based access control and federated identity across the multiple aggregated catalogs. As will be described below, the aggregated catalog may also allow for management of offerings in the aggregated catalog. For example, the options, prices and other details related to an offering may be managed via the aggregated catalog.

Lastly, as used in the present specification and in the appended claims, the term “a number of” or similar language may include any positive number including 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

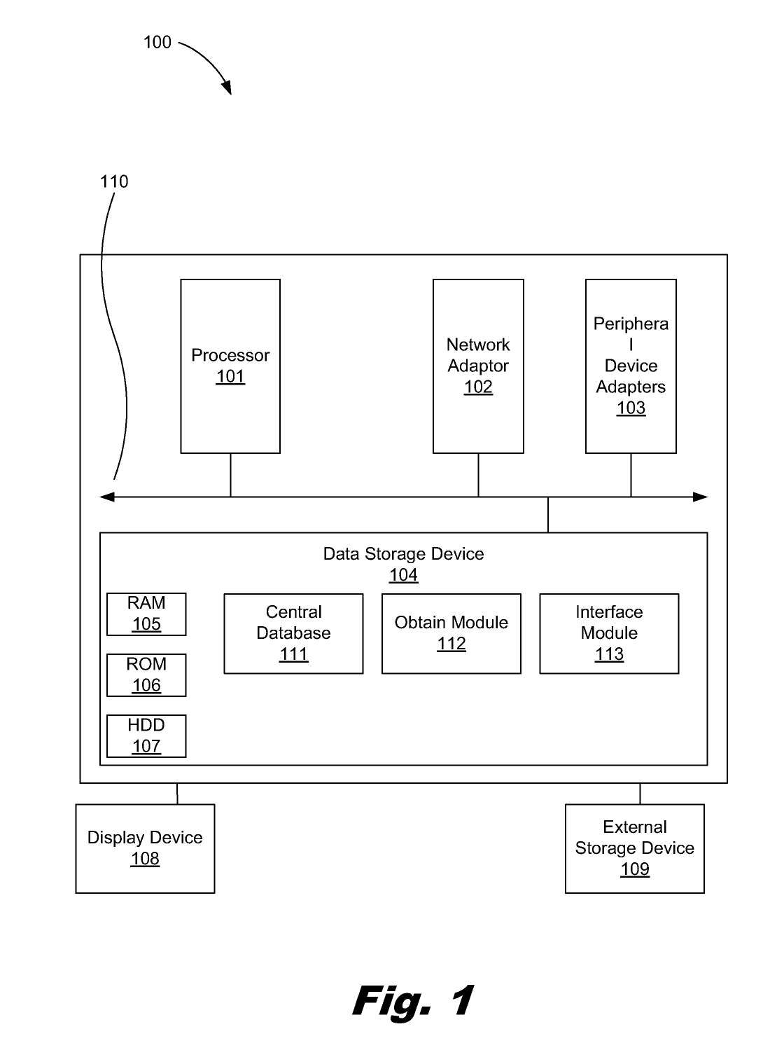

Turning now to the figures, FIG. 1 is a diagram of a system (100) for aggregating, presenting, and fulfilling a number of catalogs, according to one example of the principles described herein. The system (100) may be utilized in any data processing scenario including, for example, a cloud computing service such as a Software as a Service (SaaS), a Platform as a Service (PaaS), a Infrastructure as a Service (IaaS), application program interface (API) as a service (APIaaS), other forms of network services, or combinations thereof. Further, the system (100) may be used in a public cloud network, a private cloud network, a hybrid cloud network, other forms of networks, or combinations thereof. In one example, the methods provided by the system (100) are provided as a service over a network by, for example, a third party. In another example, the methods provided by the system (100) are executed by a local administrator.

Further, the system (100) may be utilized within a single computing device. In this data processing scenario, a single computing device may utilize the associated methods described herein to test web services using inherited test attributes.

To achieve its desired functionality, the system (100) comprises various hardware components. Among these hardware components may be a number of processors (101), a number of data storage devices (104), a number of peripheral device adapters (103), and a number of network adapters (102). These hardware components may be interconnected through the use of a number of busses and/or network connections. In one example, the processor (101), data storage device (104), peripheral device adapters (103), and a network adapter (102) may be communicatively coupled via bus (110).

The processor (101) may include the hardware architecture to retrieve executable code from the data storage device (104) and execute the executable code. The executable code may, when executed by the processor (101), cause the processor (101) to implement at least the functionality of catalog aggregation, according to the methods of the present specification described herein. In the course of executing code, the processor (101) may receive input from and provide output to a number of the remaining hardware units.

The data storage device (104) may store data such as executable program code that is executed by the processor (101) or other processing device. As will be discussed, the data storage device (104) may specifically store a number of applications that the processor (101) executes to implement at least the functionality described herein.

The data storage device (104) may include various types of memory modules, including volatile and nonvolatile memory. For example, the data storage device (104) of the present example includes Random Access Memory (RAM) (105), Read Only Memory (ROM) (106), and Hard Disk Drive (HDD) memory (107). Many other types of memory may also be utilized, and the present specification contemplates the use of many varying type(s) of memory in the data storage device (104) as may suit a particular application of the principles described herein. In certain examples, different types of memory in the data storage device (104) may be used for different data storage needs. For example, in certain examples the processor (101) may boot from Read Only Memory (ROM) (106), maintain nonvolatile storage in the Hard Disk Drive (HDD) memory (107), and execute program code stored in Random Access Memory (RAM) (105).

Generally, the data storage device (104) may comprise a computer readable medium, a computer readable storage medium, or a non-transitory computer readable medium, among others. For example, the data storage device (104) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. In another example, a computer readable storage medium may be any non-transitory medium that can contain, or store a program for use by or in connection with an instruction execution system, apparatus, or device.

The hardware adapters (103) in the system (100) enable the processor (101) to interface with various other hardware elements, external and internal to the system (100). For example, peripheral device adapters (103) may provide an interface to input/output devices, such as, for example, display device (108) or access other external devices such as an external storage device (109). The display device (108) may be provided to allow a user to interact with and implement the functionality of the system (100). The peripheral device adapters (103) may also create an interface between the processor (101) and a printer, the display device (108), or other media output device. The network adapter (102) may provide an interface to other computing devices within, for example, a network, thereby enabling the transmission of data between the system (100) and other devices located within the network.

The system (100) further comprises a number of modules used in the aggregation and presentation of a number of catalogs. The various modules within the system (100) may be executed separately. In this example, the various modules may be stored as separate computer program products. In another example, the various modules within the system (100) may be combined within a number of computer program products; each computer program product comprising a number of the modules.

The system (100) may include a central database (111) to store an aggregated catalog. As described above a catalog may include any information relating to the deployment, provisioning, and management of a cloud service. Throughout the specification, specific reference may be made to a cloud service catalog. However, the catalog may include any type of offering. For example, a catalog of any type of good, service, or other offering. The catalog may include information for any type of good, service or other offering that may be ordered and filled. In some examples, the order of a good, service or other offering may include payment, approval or other type of confirmation.

A catalog may include a listing of offerings, including such information as pricing, bundles, and different service options. The catalog may also include information that may allow a user to subscribe to an offering, request a subscription to an offering, and receive an approval of a subscription. An aggregated catalog may include this information for a number of catalogs. In other words, the aggregated catalog may include information relating to the deployment, provisioning, and management of a number of cloud services that may be presented in a number of catalogs.

The catalogs may come from a number of sources. For example, a user may design a catalog. Similarly, vendors and service providers may generate a catalog to present cloud services or any other offering that may be presented for ordering and fulfillment through the catalog. Examples of other offerings include products, services, or combinations thereof. In yet another example, various applications within an organization may implement unique catalogs. For example, a service manager may utilize a first catalog and a service automation tool may utilize a second, and distinct, catalog. Each of the different catalogs may utilize a distinct portal experience and interface for interacting with the catalog and the corresponding catalog information. Accordingly, the aggregated catalog may include catalogs provided from the number of sources. In some examples, the sources may be remote to the aggregated catalog. For example, the central database (111) may be located on a central server, and the catalogs whose information is included in the aggregated catalog, may be stored on servers that are remote to the central server. The catalog aggregation capability of the central catalog may also pull in offerings from multiple remote providers to enable the catalog provider functionality. For example, the central catalog may aggregate catalogs of multiple providers and offer it to users such as Information Technology (IT) brokers or other customers such as providers.

As described above, the central database (111) may be located on a central server. For example, from a number of servers, a particular server may be designated as a central server. The central server may include the central database (111). Any server from the number of servers may be designated as the central server. Accordingly, any server from the number of servers may include the central database (111). The central server may receive catalog information for catalogs stored on the number of servers. For example, a central server may be communicatively coupled to a number of other servers. The other servers may include catalog information relating to offerings offered on those servers. As will be described below, an obtain module (112) may obtain the catalog information, and store the catalog information and corresponding catalogs in a central database (111) to be presented as a unified aggregated catalog. In some examples, any server in the system may act as the central server and may be connected to many remote catalogs. In these examples, a server may become the central server by adding an aggregation library.

Catalog information may include information related to deployment, provision, and management, among other catalog-related information for a number of offerings. For example, catalog information may include a list of offerings service information, and access rights among other information related to the management of cloud services, or other goods or products offered in a catalog. The fulfillment of an offering may be managed via the remote catalogs, but meta-data about the offering's fulfillment, such as commercial terms, contractual terms, or service level agreement (SLA) terms may be aggregated into the central catalog. Other examples of catalog information may include, pending approvals and notifications related to the services listed in the number of catalogs.

In some examples the central database (111) may include a portion of information represented on the other servers. For example, the central database (111) may include information sufficient to present the number of catalogs. In other words, the aggregated catalog may be redundant, in part, with regards to the number of catalogs stored on the other servers.

Storing an aggregated catalog on a central database (111) may be beneficial in that it groups a number of catalogs from a number of servers. This has several benefits such as improved performance and centralized search capabilities. Accordingly, a single interface may be realized to facilitate the deployment and management of a number of catalog offerings. As a result, a simple and uniform user experience may facilitate many aspects of cloud management, which may result in a satisfactory consumer experience.

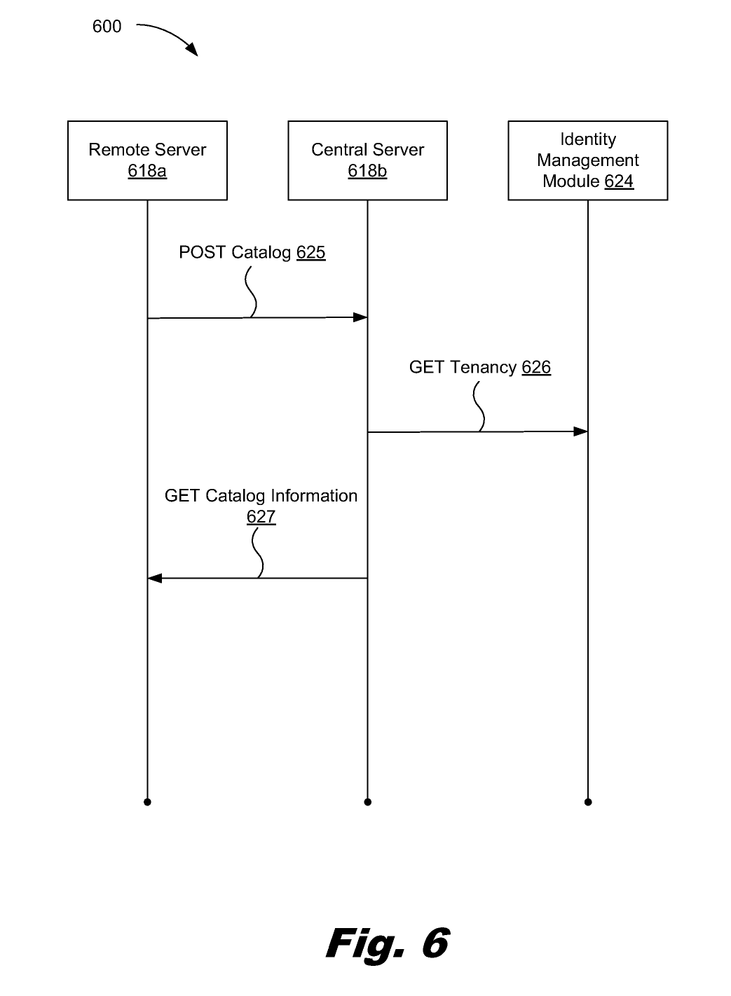

The data storage device (104) may include an obtain module (112) that obtains the catalog information from the other servers. For example, each of the servers may include an application programming interface (API) to communicate with one another. In some examples, the APIs implemented may be representational state transfer (REST) APIs. The central server, via an API located on the central server, may execute a GET request to obtain catalog information from the number of servers. As will be described in connection with FIG. 6, in some examples, the API on the central server may obtain the catalog information based on tenancy, roles, identity of users from another server, or combinations thereof. Similarly, in some examples, the API on the central server may be able to create, update, and delete the catalogs stored thereon.

The data storage device (114) may also include an interface module (113) to present the catalog information as an aggregated catalog. For example, the catalog information gathered from the number of servers may be presented as an aggregated catalog. The aggregated catalog may be a single location where a user may manage offerings. For example, a user may search a list of offerings, subscribe to an offering, receive approval for a subscription request, perform actions on the subscription, approve or deny a subscription request, gather data relating to the offering, manage the catalog, and manage access control to the offering, among other catalog offering related activities. In some examples, the management functionalities provided via the aggregated catalog may be different based on the user. For example, a user may have less management rights than an administrator.

Implementing an aggregated catalog as described herein may be beneficial in that it presents a simple and uniform user experience for accessing and managing a number of catalogs and catalog offerings, which may include cloud services. For example, rather than individually accessing user-designed catalogs, catalogs presented by vendors and other service providers, and catalogs implemented by various applications, a user, may utilize a single aggregated catalog to access the various catalogs in addition to the different management resources relating to the catalogs and corresponding services and offerings. The simplified and uniform experience may result in a satisfactory user experience and improved effectiveness of catalog use.

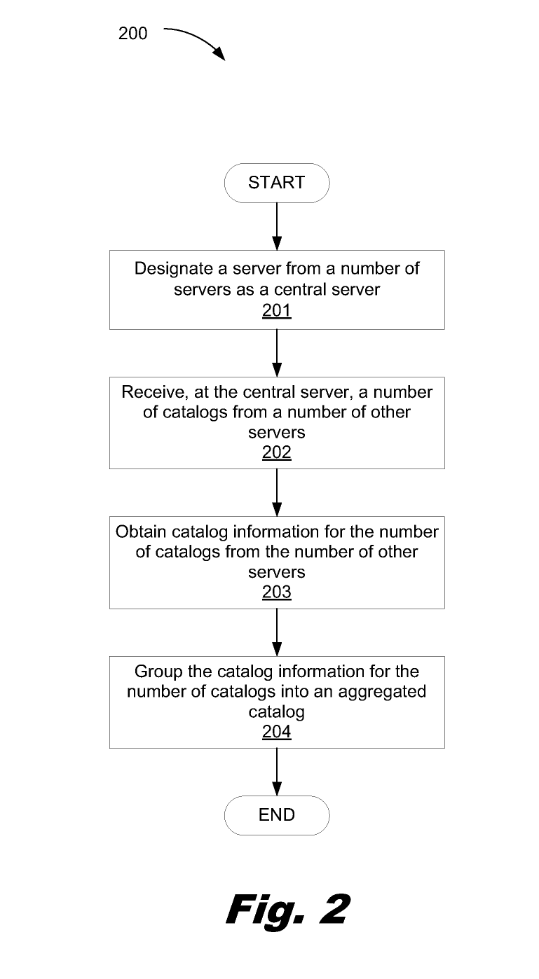

FIG. 2 is a flowchart of a method (200) for aggregating, presenting, and fulfilling a number of catalogs, according to one example of the principles described herein. The method (200) may begin by designating (block 201) a server from a number of servers as the central server. As described above, the central server may include the central database (FIG. 1, 111) that includes the aggregated catalog. In some examples, a number of the servers may be remote to one another. In other words, the number of servers may include on premises servers and off premises servers. Accordingly, in some examples, the number of other servers may be remote to the central server.

Any one of the number of servers may be designed to act as the central server. For example, the central server may include an obtain module (FIG. 1, 112) that includes an API that retrieves catalog information from other servers. Accordingly, each of the number of servers may include an API that carries out this functionality.

The central server may receive (block 202) a number of catalogs from a number of other servers. For example, as described above, each of the number of servers may include an API that allows the number of servers to communicate with one another. Accordingly, the APIs on a number of other servers may send catalogs to the central server. More specifically, an API may use a POST command to send a catalog to the central server. Accordingly, the central server may receive (block 202) catalogs from a number of other servers that may be remote to the central server.

The central server may obtain (block 203) catalog information for the number of catalogs. Again, using an API attached to the central server, the central server may execute a GET command to obtain catalog information for the number of received catalogs. As described above, the catalog information may be information that facilitates access to the catalog and corresponding services and offerings. For example, the catalog information may include service offerings, subscription requests, subscription approvals, subscription notifications, or combinations thereof. Catalog information may also include other information relating to catalogs, services, the management of clouds and services, as discussed herein.

Similarly, as described above, the catalog information obtained (block 203) by the central server may be a portion of the catalog information contained on the number of other servers. For example, the central server may obtain (block 203) catalog information sufficient to present the catalog in the aggregated catalog. Accordingly, a portion of the data contained in the central database (FIG. 1, 111) may be redundant to data contained in the number of other servers.

The catalog information for the number of catalogs may be grouped (block 204) into an aggregated catalog. More specifically, the catalog information that corresponds to various catalogs may be presented in a single interface. Accordingly, the aggregated catalog may present information relating catalogs in a single location, regardless of the source of the catalog.

Grouping (block 204) a number of catalogs as a single aggregated catalog may be beneficial in that it creates a single location where multiple catalogs may be accessed. Additionally, the access to catalog information may be simplified as an aggregated catalog may implement a single interface with a uniform look, rather than multiple catalogs presented using different interfaces and varying looks. In some examples, the remote and central catalogs may be synchronized using an API. For example, when a new offering is created in a remote catalog, it may be aggregated and presented in the central catalog. In some examples, although the catalogs may have different models, alignment of terminology and models may occur in the implementation of the API.

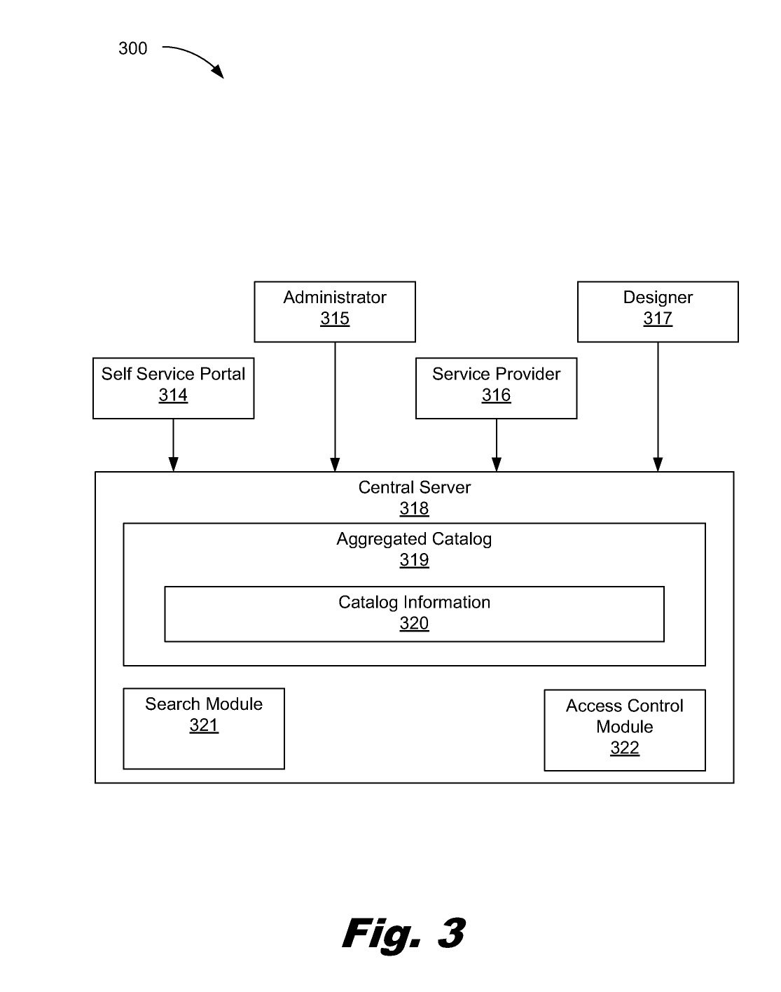

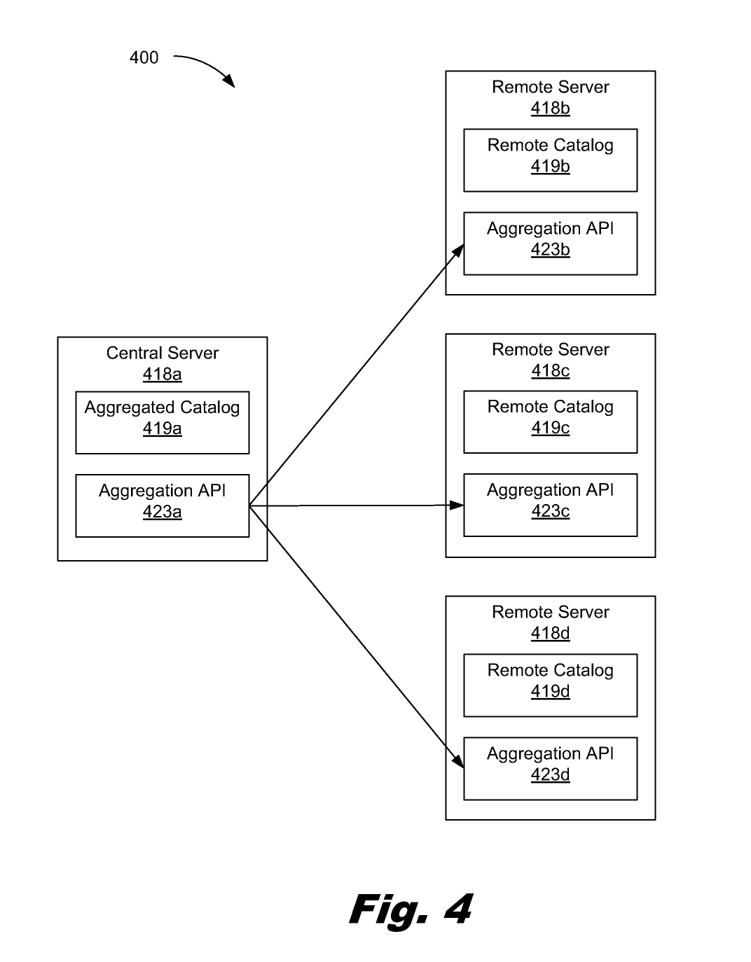

FIG. 3 is a diagram of another system (300) for aggregating, presenting, and fulfilling a number of catalogs, according to one example of the principles described herein. As described above, a central server (318) may include the central database (FIG. 1, 111) which may include an aggregated catalog (319). In some examples, the aggregated catalog (319) may be a virtual catalog that includes catalog information (320) for a number of other, and sometimes remote, catalogs. For example, the aggregated catalog (319) may include a listing of catalogs and a listing of service offerings. Other examples of catalog information (320) that may be included in the aggregated catalog (319) includes subscription approvals, notifications, subscription information, subscription requests, pricing, configuration options, and quotas, among other catalog information. In some examples, the aggregated catalog (319) may be stored in a cache of the central server (318). As will be described in connection with FIG. 4, the central server (318) may also include an API for aggregating catalogs from remote servers. As described above, any of the number of servers may act as the central server (318). Accordingly, each of the number of servers may include any number of the modules or other elements described in connection with FIG. 3.

The central server (318) may also include an API (not shown) that facilitates consumption of, or access to, the aggregated catalog (319). Via this API, different users may access the aggregated catalog (319). For example, users, via a self service portal (314) may access the aggregated catalog (319) to subscribe to a service, search offerings, and manage a subscription, among other cloud service and catalog management-related activities. The self service portal (314) may facilitate this management via an API. In some examples, managing a subscription via the central server (318) may include calling an original application that corresponds to the subscription. For example, when managing a subscription, the original application may include logic to modify or process a subscription. Processing a subscription may include managing a life cycle of a realized service by a cloud service automation tool and checking a status of a ticket, among other subscription processing resources. When a service is subscribed to via the aggregated catalog (319), the subscription request may be delegated to a remote catalog for fulfillment, and the information relative to the service offering's fulfillment may be aggregated back to the aggregated catalog (319).

Another example of a user that may access the central server (318) is an administrator (315) to manage the aggregated catalog (319) presentation and to manage the central server (318). Other vendors and service providers (316) may also have access to the central server (319) to include their catalogs to the aggregated catalog (319) or to subscribe to, and manage, cloud services, or other offerings.

In yet another example, designers (317) may have access to the aggregated catalog (319). More specifically, a designer (317) may have access to a design function included in the aggregated catalog (319) to allow the designer (317) to design a particular service offering. A design API may allow the designer (317) to design a service offering.

The central server (318) may include a search module (321) that facilitates a search of the aggregated catalog (319). For example, a user may desire a particular type of service offering, or may desire a service offering with a particular name. Using the search module (321), the central server (318) may identify and present catalog information (320) based on search criteria entered by the user.

The central server (318) may include an access control module (322) that manages access to the central server (318) and more specifically to the aggregated catalog (319). The access control module (322) may include an identity management service. The access control module (322) may provide access control based on roles of users. The access control module (322) may allow access, deny access, determine a level of access, or combinations thereof based on the role of a user. For example, an administrator (315) may have greater access to the central server (318) than a user via the self service portal (314). Using role based access control in this fashion ensures the central server (318) security.

The access control module (322) may also provide an identity management function. For example, as described above, tenants may be users who have access to the central server (318) and the aggregated catalog (319). Such tenants may have access to different catalogs. For example, an accounting department may have access to a first set of offerings and a human resources department may have access to a second set of offerings that may include a number of offerings that are different than those of the first set. Accordingly, the access control module (322) may determine tenancy and provide access to the aggregated catalog (319) based on the tenancy. In some examples, the access control module (322) may be utilized as an Identity as a Service (IDaaS) infrastructure.

Fulfillment of the offerings selected from the aggregated catalog (319) may be carried out by a fulfillment module located on the remote servers. Fulfillment of an offering may include deployment and management of the offering or delivery of items from the catalog. Fulfillment may also include realization of a service design. A central server (318) that includes an aggregated catalog (319) as described in connection with FIG. 3 may be beneficial in that it provides a simplification and unification of a user experience as well as providing an extensive and customizable platform to develop applications and services.

FIG. 4 is a diagram of a number of servers (418) for aggregating, presenting, and fulfilling a number of catalogs, according to another example of the principles described herein. A central server (418a) may include an aggregated catalog (419a). As described above, the aggregated catalog (419a) may include catalog information (FIG. 3, 320) that facilitates access to a number of remote catalogs (419b, 419c, 419d). The aggregated catalog (419a) may also include catalog information (FIG. 3, 320) that facilitates management of the services and offerings provided by the number of remote catalogs (419b, 419c, 419d). Accordingly, the aggregated catalog (419a) may be a virtual catalog that may be consumed using a number of consumption APIs. The central server (418a) and the remote servers (418b, 418c, 418d) may include aggregation APIs (423) that facilitate the aggregation of the remote catalogs (419b, 419c, 419d). For example, the aggregation APIs (423b, 423c, 423d) on the remote servers (418b, 418c, 418d) may create catalogs on the central server (418a) using a POST command. Similarly, the aggregation API (423a) on the central server (418a) may obtain catalog information (FIG. 3, 320) relating to the remote catalogs (419b, 419c, 419d) using a GET command.

As described above, each server (418) may include aggregation APIs (423) that may allow each server (418) to act as a central server (418a). For example, a second remote server (418b) may be designated as the central server and may obtain catalog information (FIG. 3, 320) using a GET command.

In some examples, a catalog may be a legacy catalog. A legacy catalog may be a catalog that cannot act as an aggregated catalog (419a). These legacy catalogs may include adapters to allow the catalog to implement the behavior of an aggregation API (423c) with regards to posting a catalog to an aggregated catalog (419a).

While FIG. 4 depicts three remote servers (418b, 418c, 418d) and corresponding remote catalogs (419b, 419c, 419d), any number of servers (418b, 418c, 418d) and catalogs (419b, 419c, 419d) may be implemented in accordance with the principles described herein. Moreover, while the servers (418b, 418c, 418d) and catalogs (419b, 419c, 419d) are designated as remote, indicating they are off premises, the servers and catalogs that are provided in the aggregated catalog (FIG. 4, 419a) may be any combination of off premises servers or on premises servers.

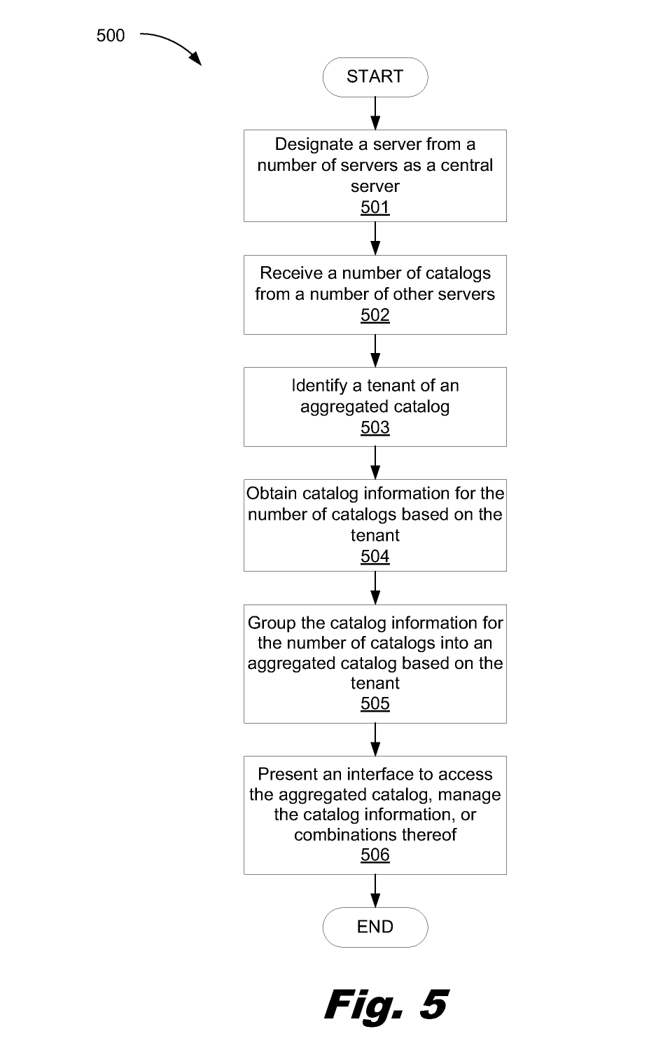

FIG. 5 is a flowchart of another method (500) for aggregating, presenting, and fulfilling a number of catalogs (FIG. 4, 418b, 418c, 418d), according to one example of the principles described herein. The method (500) may include designating (block 501) a server from a number of servers as a central server (FIG. 3, 319). This may be performed as described in connection with FIG. 2.

The central server (FIG. 3, 319) may receive (block 502) a number of catalogs from a number of other servers. This may be performed as described in connection with FIG. 2.

The central server (FIG. 3, 319) may identify (block 503) a tenant of an aggregated catalog. As described above a tenant may be a user of the aggregated catalog (FIG. 3, 320). For example, an accounting department of an organization may be a tenant and a human resources department may be another tenant. The aggregated catalog (FIG. 3, 320) may be a multi-tenancy catalog in that multiple tenants may have access to the aggregated catalog (FIG. 3, 320). For example, both the accounting department and the human resources department may have access to the aggregated catalog (FIG. 3, 320).

In some examples, each tenant may have different access capabilities. For example, the accounting tenant may have access to a first number of offerings represented in the aggregated catalog (FIG. 3, 320) and the human resources tenant may have access to a second number of offerings represented in the aggregated catalog (FIG. 3, 320) which second set may be different, at least in part, than the first set. Accordingly, the central server (FIG. 3, 319) may identify (block 503) a tenant of the aggregated catalog (FIG. 3, 320).

Identifying (block 503) a tenant may include receiving, and authenticating, a user login. For example, the central server (FIG. 3, 319) may receive a username and password from a user and may identify (block 503) the tenant based on the username and password. Identifying (block 503) a tenant may include obtaining tenant information, such as metadata, that identifies the tenant.

The central server may obtain (block 504) catalog information for the number of catalogs based on the tenant. In some examples, this may be performed as described in connection with FIG. 2. For example, using an API attached to the central server (FIG. 3, 318), the central server (FIG. 3, 318) may execute a GET command to obtain catalog information (FIG. 3, 320) for the number of received catalogs. More specifically, the central server (FIG. 3, 318) may execute a GET command to obtain catalog information (FIG. 3, 320) for a number of catalogs that the tenant has access to.

As described above, the catalog information (FIG. 3, 320) may be information that facilitates access to the catalog and corresponding services and offerings. For example, the catalog information (FIG. 3, 320) may include service offerings, subscription requests, subscription approvals, subscription notifications, or combinations thereof. Catalog information (FIG. 3, 320) may also include other information relating to catalogs, services, the management of clouds and services, as discussed herein.

Similarly, as described above, the catalog information (FIG. 3, 320) obtained (block 504) by the central server (FIG. 3, 318) may be a portion of the catalog information (FIG. 3, 320) contained on the number of other servers. For example, the central server (FIG. 3, 318) may obtain (block 504) catalog information (FIG. 3, 320) sufficient to present the catalog in the aggregated catalog (FIG. 3, 319). Accordingly, a portion of the data contained in the central database (FIG. 1, 111) may be redundant to data contained in the number of other servers.

The catalog information (FIG. 3, 320) for the number of catalogs that a tenant has access to may be grouped (block 505) into an aggregated catalog (FIG. 3, 319). More specifically, the catalog information (FIG. 3, 320) that corresponds to various catalogs may be presented in a single interface. Accordingly, the aggregated catalog (FIG. 3, 319) may present information relating catalogs in a single location, regardless of the source of the catalog.

The central server (FIG. 3, 318) may present (block 506) an interface to access the aggregated catalog (FIG. 3, 319). The interface may also facilitate management of the catalog information. For example, via the interface a user may submit a subscription request, receive a request approval, view pricing, and bundling information for service offerings, among other access and management operations described herein.

FIG. 6 is a thread diagram (600) of a method of acquiring catalog information, according to one example of the principles described herein. A remote server (618a) may execute a POST command to send a catalog (block 625) to the central server (618b). In other words, the remote server (618a) may create a catalog on the central server (618b) to be included in the aggregated catalog (FIG. 3, 319a).

The central server (618b) may then execute a GET command to get the tenancy (block 626) from the identity management module (624). As described above, the tenancy of a user may indicate the access of a user. More specifically, the tenancy may indicate which of the remote catalogs (FIG. 4, 419b, 419c, 419d) a tenant has access to.

The central server (618b) may then execute a GET command to get the catalog information (FIG. 3, 320) (block 627) from the remote server (618a). In addition to the examples described herein, the catalog information (FIG. 3, 320) may include a list of offerings, a list of subscriptions, a list of pending approvals, a list of notifications, and a list of services. As described above, when an administrator makes modifications in the remote catalog, those changes may be synchronized to the aggregated catalog (FIG. 3, 319) automatically using the aggregation API.

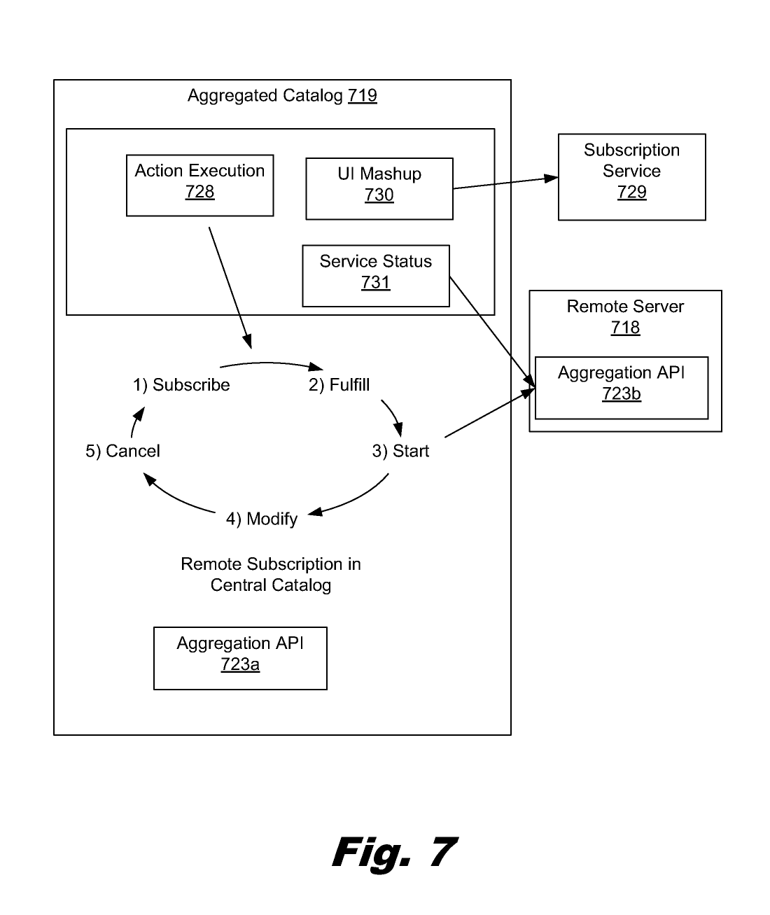

FIG. 7 is a diagram of a system for fulfilling an offering, according to one example of the principles described herein. Subscriptions presented in the aggregated catalog (719) may be managed in a variety of ways. In other words, there may be many ways to manage the lifecycle of a service subscription. A service subscription may include subscribing to, fulfilling, starting, modifying, cancelling, among other operations, a service. As used herein, the management of the lifecycle of a service subscription may refer to actions executed by an action execution module (728) on the subscription itself, actions performed on the services represented by a subscription, or combinations thereof. For example, a service subscription may expose several lifecycle actions to the user of the aggregated catalog (FIG. 719). Examples of such lifecycle actions include, “cancel”, “pause” or “resume” actions.

An aggregation API (723a) on the aggregated catalog (719) may enable the representation of these actions in the aggregated catalog's (719) interface, and may subsequently expose a remote execution interface for the delegated actions to be performed against the remote fulfillment engine or actual service (729). Additionally, the aggregated catalog (719) may aggregate information about the service subscription to be presented in the aggregated catalog's (719) user interface (UI) “mash-up” (730). The information may be displayed natively as a component in the user interface of the aggregated catalog (719), cross-launched, or displayed on an embedded screen.

As described above, in some examples, a remote server (718) may be delegated the fulfillment of a service, via the UI mash-up, (730), for example. Accordingly, a service status (731) may be communicated to the remote server (718) for continued interaction with the service, via an aggregation API (723b) on the remote server (718), for example.

Methods and systems for aggregating, presenting, and fulfilling a number of catalogs may have a number of advantages, including: (1) presenting a single user experience for catalog navigation; (2) allowing consumers to more easily adapt and migrate between catalogs; (3) increasing marketing of cloud services; and (4) aggregating off-premises cloud services and on-premises cloud services.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for aggregating, presenting, and fulfilling a number of catalogs, comprising:
designating a server from a number of servers as a central server;
receiving, at the central server, a number of catalogs from a number of other servers;
obtaining catalog information for the number of catalogs from the number of other servers; and
grouping the catalog information for the number of catalogs into an aggregated catalog.

2. The method of claim 1, in which receiving a number of catalogs is performed by an application programming interface (API) that receives the number of catalogs from an application programming interface (API) on another server.

3. The method of claim 1, further comprising delegating the fulfillment of an offering, approval of an offering, management of an offering or combinations thereof, to a remote catalog.

4. The method of claim 1, in which the catalog information includes offerings, subscriptions, approvals, notifications, or combinations thereof.

5. The method of claim 1, in which the catalog information includes information to allow access to the catalog.

6. The method of claim 1, in which each of the number of servers is designed to act as a central server.

7. The method of claim 1, further comprising identifying a tenant of a catalog and in which obtaining catalog information for the number of catalogs from the number of other servers and grouping the catalog information for the number of catalogs into an aggregated catalog is based on the tenant.

8. The method of claim 1, further comprising presenting an interface to access the aggregated catalog, managing the catalog information or combinations thereof.

9. A system for aggregating, presenting, and fulfilling a number of catalogs, comprising:
a central database to store an aggregated catalog, in which the aggregated catalog comprises catalog information for a number of catalogs;
an obtain module to obtain the catalog information from a number of a servers; and
an interface to present the catalog information as an aggregated catalog.

10. The system of claim 9, in which the obtain module comprises an application programming interface (API).

11. The system of claim 10, in which the API creates an aggregated catalog, updates an aggregated catalog, deletes an aggregated catalog, or combinations thereof.

12. The system of claim 9, in which the central database is located on a central server that is selected from a number of servers.

13. The system of claim 9, further comprising an access control module to control access to the aggregated catalog.

14. A computer program product for aggregating, presenting, and fulfilling a number of catalogs, the computer program product comprising:
a computer readable storage medium comprising computer usable program code embodied therewith, the computer usable program code comprising computer usable program code to, when executed by a processor:
designate a server from a number of servers as a central server;
receive, at the central server, a number of catalogs from the number of servers;
obtain, from a number of servers, catalog information relating to a number of catalogs;
group the catalog information into an aggregated catalog; and
present the aggregated catalog.

15. The computer program product of claim 14, in which a number of servers are remote to the central server.
